(19) United States
(12) Patent Application Publication
(10) Pub. No.: US 2023/0294010 A1
(43) Pub. Date: Sep. 21, 2023

(54) Portable Activity Board Device

(71) Applicant: Troy Hyde, Phoenix, AZ (US)

(72) Inventor: Troy Hyde, Phoenix, AZ (US)

(21) Appl. No.: 17/879,325

(22) Filed: Aug. 2, 2022

Related U.S. Application Data
(60) Provisional application No. 63/321,138, filed on Mar. 18, 2022.

(51) Int. Cl. A63H 33/00; B60R 7/04; A63H 33/10

(52) U.S. Cl. CPC A63H 33/006; B60R 7/043; A63H 33/107

(57) ABSTRACT

The present invention relates to a novel activity board device. The device is designed to keep a child occupied, entertained, and happy while in a car, playing at home, in a restaurant, etc. Specifically, the portable activity board device comprises attachable toys and accessories. The activity board device can be secured around the headrest of a vehicle or placed on a flat surface for play.

### CROSS-REFERENCE TO RELATED APPLICATION

The present application claims priority to, and the benefit of, U.S. Provisional Application No. 63/321,138, which was filed on Mar. 18, 2022 and is incorporated herein by reference in its entirety.

### FIELD OF THE INVENTION

The present invention relates generally to the field of activity board devices. More specifically, the present invention relates to an improved activity board device that provides users with a child's activity board comprising several attachable toys and accessories. Accordingly, the present disclosure makes specific reference thereto. Nonetheless, it is to be appreciated that aspects of the present invention are also equally applicable to other like applications, devices and methods of manufacture.

### BACKGROUND

By way of background, keeping an infant or toddler entertained for extended periods of time can be difficult, especially when traveling in a vehicle. An upset or anxious child can lead to driver distractions, ultimately taking the driver's eyes off the road, which can cause accidents. Accordingly, devices that soothe children during extended car rides would be advantageous.

Furthermore, young children can get bored without toys to play with at a restaurant, outside, at home, in a car, etc. However, loose or individual toys can make a mess and require constant cleanup by the parent. Thus, devices that provide children with toys to play with, specifically, toys that are attached to the device and are not removed would be advantageous.

Therefore, a novel child's activity board device is needed that can prevent small children from getting bored and/or upset during car rides, or at restaurants, etc. Further, a useful device is needed that allows children to play with toys without worry of losing or misplacing the toys within the car or restaurant, etc.

Therefore, there exists a long-felt need in the art for a portable activity board device that keeps a child occupied, entertained, and happy while in a vehicle, playing at home, or in a restaurant, etc. There is also a long-felt need in the art for a portable activity board device that provides users with a unique and customizable activity board for children with attachable toys and accessories. Further, there is a long-felt need in the art for a portable activity board device that can be used on a flat surface, such as the floor or secured to a vehicle headrest. Moreover, there is a long-felt need in the art for a device that allows users to attach virtually any type of toy to the activity board. Further, there is a long-felt need in the art for a portable activity board device that includes multiple apertures on the front side of the activity board for receiving toys. Finally, there is a long-felt need in the art for a portable activity board device that also allows toys to be interchanged with new toys, and then these new toys are secured to the activity board.

The subject matter disclosed and claimed herein, in one embodiment thereof, comprises a portable activity board device. The device is designed to keep a child occupied, entertained, and happy while in a car, playing at home, in a restaurant, etc. Specifically, the portable activity board device comprises attachable toys and accessories. The device comprises a housing component which comprises a flat front and back section, configured in a trapezoid-shaped configuration or an “A-frame” configuration. The flat front and back sections comprise a plurality of apertures configured to receive toys, attached with screws or other fasteners. Multiple toys can be attached simultaneously for the child to play with. The activity board device can be secured around the headrest of a vehicle or placed on a flat surface for play.

In this manner, the portable activity board device of the present invention accomplishes all of the foregoing objectives and provides users with a device with a unique and customizable activity board. The device is configured to retain several attachable toys and accessories, which can be swapped out with new toys and accessories, as needed. The device can be sold as an empty board, a kit or a base set with predetermined toys.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable activity board device. The device is designed to keep a child occupied, entertained, and happy while in a car, playing at home, in a restaurant, etc. Specifically, the portable activity board device comprises attachable toys and accessories. The device comprises a housing component which comprises a flat front and back section, configured in a trapezoid-shaped configuration. The flat front and back sections comprise a plurality of apertures configured to receive toys, attached with screws or other fasteners. Multiple toys can be attached simultaneously for the child to play with. The activity board device can be secured around the headrest of a vehicle or placed on a flat surface for play.

In one embodiment, the housing component comprises a flat front and back section secured together at one edge via a hinge, a living hinge, etc., or other suitable fasteners as is known in the art which allow the flat front and back sections to move in an open and closed position. Further, once in an open position, the housing component is in the shape of a trapezoid and can be secured so as not to overextend its open position. Specifically, flexible straps or fabric roping, etc., or any other suitable securing means as is known in the art, is secured to the opposing edges of the front and back sections to span the opening and prevent overextension of the housing component. In other embodiments, the housing component can be any suitable shape as is known in the art, such as square, rectangle, oval, etc., depending on the needs and/or wants of a user. Further, in a closed position, the front and back sections of the housing component lay flat on each other.

In one embodiment, the housing component comprises a plurality of apertures secured to the front and back sections. Any suitable number of apertures can be included as is known in the art, depending on the needs and/or wants of a user. In one embodiment, only the front section comprises apertures. In one embodiment, only the back section comprises apertures. In one embodiment, both the front and the back sections comprise apertures. Further, the apertures can be any suitable size as is known in the art, and the plurality of apertures can comprise a plurality of different sizes based on the toys and/or accessories being secured to the housing component.

In one embodiment, a plurality of toys are secured to the front and back sections of the housing component. The toys are secured via screws or other suitable fasteners as is known in the art, utilizing the apertures. Multiple toys can be secured simultaneously for the child to play with. Any type of toy and accessory can be utilized depending on the needs and/or wants of a user, as long as the toy and/or accessory can be secured via fasteners through the apertures.

In one embodiment, the portable activity board device is sold as a kit with a base set of toys included. In another embodiment, supplemental age-based toy kits can be sold, as the child grows. In another embodiment, a subscription-based service can be provided, in which users (parents) can pay a monthly fee to have different types of toys delivered for their child, based on his or her development age and/or interests.

In one embodiment, the portable activity board device can be used in two different configurations. In one configuration, the portable activity board device is secured around a vehicle headrest via a strap or other securing mechanism as is known in the art. Once in position, the front section of the housing component hangs down in front of a child while he or she sits in their car seat, allowing the child to interact with the multiple toys and/or accessories secured to the front section. In the second configuration, the portable activity board device can be placed on a flat surface, such as the floor, a table, the ground, etc., or any other suitable place as is known in the art, depending on the needs and/or wants of a user. Both configurations are intended to keep a child happy, entertained, and busy while in a vehicle, in a restaurant, at home, etc., or any other locations. Further, as the toys are secured to the housing component, a user need not worry about toys that can be thrown or lost in the vehicle, restaurant, house, etc.

In one embodiment, the portable activity board device comprises a handle secured to either the front section or the back section, for easy transport of the device.

In another embodiment, the portable activity board device comprises a plurality of indicia on the housing component.

In yet another embodiment, the portable activity board device is manufactured from wood, plastic or polymers, such as polypropylene or acrylonitrile-butadiene-styrene (ABS), polycarbonate, polyethylene, fiberglass, etc., or any other suitable materials as is known in the art.

In yet another embodiment, the portable activity board device is manufactured from a material that is water resistant.

In yet another embodiment, a method of keeping a child occupied, entertained, and happy while in a vehicle, at home, or in a restaurant is described. The method includes the steps of providing an activity board that receives toys and accessories. The method also comprises securing several toys and accessories to the activity board via screws or other fasteners. Further, the method comprises attaching the activity board to the back of a vehicle headrest or placing the activity board on the floor for play allowing the child to play and interact with the activity board.

In yet another embodiment of the present invention, a portable activity board device is disclosed for keeping a child happy, entertained, and busy while in a vehicle, a restaurant, or at home, without worry of a child throwing toys and/or losing toys. The device comprises a housing component comprising a front and back section secured at an edge via a hinge. The hinge allows the front and back sections to be moved in an open and closed position. Once in an open position, the housing component can be secured so as not to overextend its open position. The device is then either secured around a vehicle headrest or placed on a flat surface for use, allowing a child to interact with the multiple toys and/or accessories secured to the front section of the housing component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the portable activity board device of the present invention in use in a vehicle in accordance with the disclosed architecture;

FIG. 1B illustrates a perspective view of one potential embodiment of the portable activity board device of the present invention in use on a floor in accordance with the disclosed architecture;

FIG. 2 illustrates a perspective view of another potential embodiment of the portable activity board device of the present invention in use on the ground in accordance with the disclosed architecture;

FIG. 3 illustrates a perspective view of another potential embodiment of the portable activity board device of the present invention in use in a vehicle in accordance with the disclosed architecture;

FIG. 4 illustrates a perspective view of how one potential embodiment of the portable activity board device of the present invention is secured to a headrest of a vehicle in accordance with the disclosed architecture;

FIG. 5 illustrates a perspective view of how the toys are secured to one potential embodiment of the activity board of the present invention in accordance with the disclosed architecture; and

FIG. 6 illustrates a flowchart showing a method of keeping a child occupied, entertained, and happy while in a vehicle, at home, or in a restaurant via the activity board of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a portable activity board device that keeps a child occupied, entertained, and happy while in a vehicle, playing at home, or in a restaurant, etc. There is also a long-felt need in the art for a portable activity board device that provides users with a unique and customizable activity board for children with attachable toys and accessories. Further, there is a long-felt need in the art for a portable activity board device that can be used on a flat surface, such as the floor or secured to a vehicle headrest. Moreover, there is a long-felt need in the art for a device that allows users to attach virtually any type of toy to the activity board. Further, there is a long-felt need in the art for a portable activity board device that includes multiple apertures on the front side of the activity board for receiving toys. Finally, there is a long-felt need in the art for a portable activity board device that also allows toys to be interchanged with new toys, and then these new toys are secured to the activity board.

The present invention, in one exemplary embodiment, is a novel portable activity board device that comprises attachable toys and accessories. The device comprises a housing component which comprises a flat front and back section, configured in a trapezoid-shaped configuration. The flat front and back sections comprise a plurality of apertures configured to receive toys, attached with screws or other fasteners. Multiple toys can be attached simultaneously for the child to play with. The activity board device can be secured around the headrest of a vehicle or placed on a flat surface for play. The present invention also includes a novel method of keeping a child occupied, entertained, and happy while in a vehicle, at home, or in a restaurant. The method includes the steps of providing an activity board that receives toys and accessories. The method also comprises securing several toys and accessories to the activity board via screws or other fasteners. Further, the method comprises attaching the activity board to the back of a vehicle headrest or placing the activity board on the floor for play. Finally, allowing the child to play and interact with the activity board.

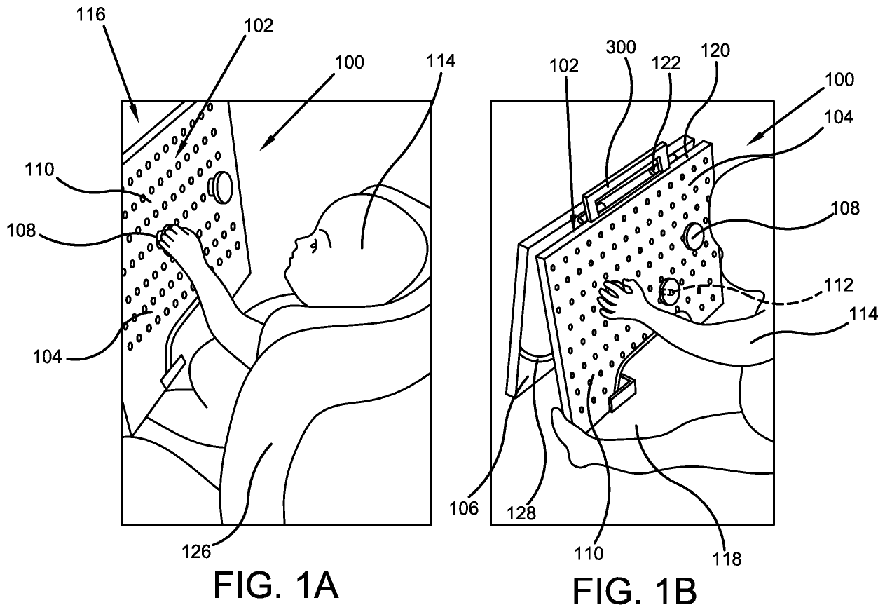

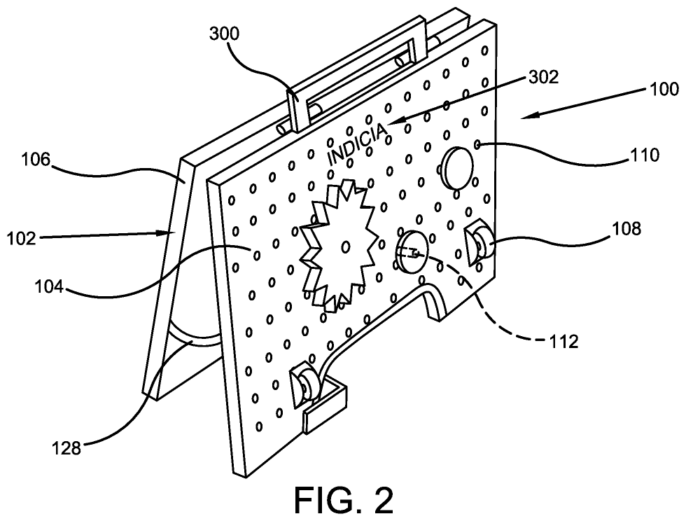

Referring initially to the drawings, FIGS. 1A-B and 2 illustrate a perspective view of one embodiment of the portable activity board device 100 of the present invention. In the present embodiment, the portable activity board device 100 is an improved activity board device that keeps a child occupied, entertained, and happy while in a vehicle, playing at home, or in a restaurant, etc., or any other suitable place as is known in the art. The device 100 is especially designed to allow a parent, guardian, caregiver, etc., or any other suitable user as is known in the art, to provide children with a unique and customizable activity board. Specifically, the portable activity board device 100 comprises attachable toys 108 and accessories. More specifically, the device 100 comprises a housing component 102, comprising a flat, front 104 and back 106 sections, configured in a trapezoid-shaped configuration. Further, any suitable shape as is known in the art, such as square, rectangle, oval, etc., can be utilized depending on the needs and/or wants of a user. The flat front 104 and back 106 sections comprise a plurality of apertures 110 configured to receive toys 108, attached with screws 112 or other suitable fasteners as is known in the art. Multiple toys 108 can be attached simultaneously for the child 114 to play with, (as shown in FIG. 2), depending on the needs and/or wants of a user. The activity board device 100 can be secured around the headrest 116 of a vehicle (as shown in FIG. 1A) or placed on a flat surface 118 for play (as shown in FIG. 1B).

In one embodiment, the housing component 102 comprises a flat front 104 and back 106 section secured together at one edge 120 via a hinge 122, a living hinge, etc., or other suitable fasteners as is known in the art, which allow the flat front 104 and back 106 sections to move in an open and closed position. Further, once in an open position (shown in FIG. 2), the housing component 102 is in the shape of a trapezoid and can be secured so as not to overextend its open position. Specifically, flexible straps 128 or fabric roping, etc., or any other suitable securing means as is known in the art, is secured to the opposing edges 120 of the front 104 and back 106 sections to span the opening and prevent overextension of the housing component 102. In other embodiments, the housing component 102 can be any suitable shape as is known in the art, such as square, rectangle, oval, etc., depending on the needs and/or wants of a user. Further, in a closed position, the front 104 and back 106 sections of the housing component 102 lay flat on each other.

Furthermore, the housing component 102 comprises a plurality of apertures 110 secured to the front 104 and back 106 sections. Any suitable number of apertures 110 can be included as is known in the art, depending on the needs and/or wants of a user. In one embodiment, only the front section 104 comprises apertures 110. In one embodiment, only the back 106 section comprises apertures 110. In one embodiment, both the front 104 and the back 106 sections comprise apertures 110. Further, the apertures 110 can be any suitable size as is known in the art, and the plurality of apertures 110 can comprise a plurality of different sizes based on the toys 108 and/or accessories being secured to the housing component 102.

Accordingly, based on the plurality of apertures 110, a plurality of toys 108 are secured to the front 104 and back 106 sections of the housing component 102. The toys 108 are secured via screws 112 or other suitable fasteners as is known in the art, utilizing the apertures 110. Multiple toys 108 can be secured simultaneously for the child 114 to play with. Any type of toy 108 and accessory can be utilized depending on the needs and/or wants of a user, as long as the toy 108 and/or accessory can be secured via fasteners 112 through the apertures 110.

As shown in FIGS. 1A-B, the portable activity board device 100 can be used in two different configurations. In one configuration shown in FIG. 1A, the portable activity board device 100 is secured around a vehicle headrest 116 via a strap 124 or other securing mechanism as is known in the art. Once in position, the front section 104 of the housing component 102 hangs down in front of a child 114 while he or she sits in their car seat 126, allowing the child 114 to interact with the multiple toys 108 and/or accessories secured to the front section 104. In the second configuration shown in FIG. 1B, the portable activity board device 100 can be placed on a flat surface 118, such as the floor, a table, the ground, etc., or any other suitable place as is known in the art, depending on the needs and/or wants of a user. Both configurations are intended to keep a child 114 happy, entertained, and busy while in a vehicle, in a restaurant, at home, etc., or any other locations. Further, as the toys 108 are secured to the housing component 102, a user need not worry about toys 108 that can be thrown or lost in the vehicle, restaurant, house, etc.

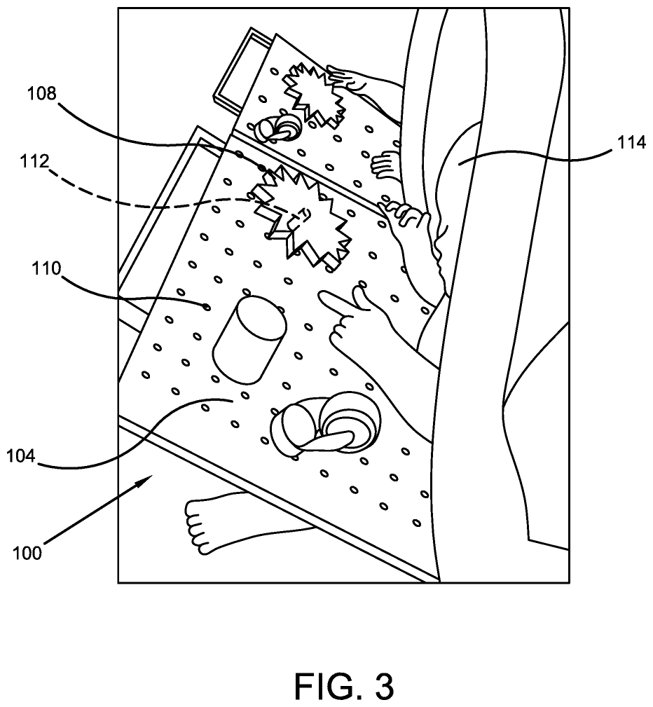

FIG. 3 illustrates a perspective view of another embodiment of the portable activity board device 100 of the present invention. The portable activity board device 100 comprises a handle 300 secured to either the front section 104 or the back section 106, for easy transport of the device 100. Further, in one embodiment, two handles 300 can be secured to the device 100, one handle 300 on the front section 104 and one handle 300 on the back section 106.

Additionally, the portable activity board device 100 comprises a plurality of indicia 302 on the housing component 102. For example, the housing component 102 of the portable activity board device 100 may include advertising, a trademark, or other letters, designs, or characters, printed, painted, stamped, or integrated into the housing component 102, or any other indicia 302 as is known in the art. Specifically, any suitable indicia 302 as is known in the art can be included, such as but not limited to, patterns, logos, emblems, images, symbols, designs, letters, words, characters, animals, advertisements, brands, etc., that may or may not be child or brand related.

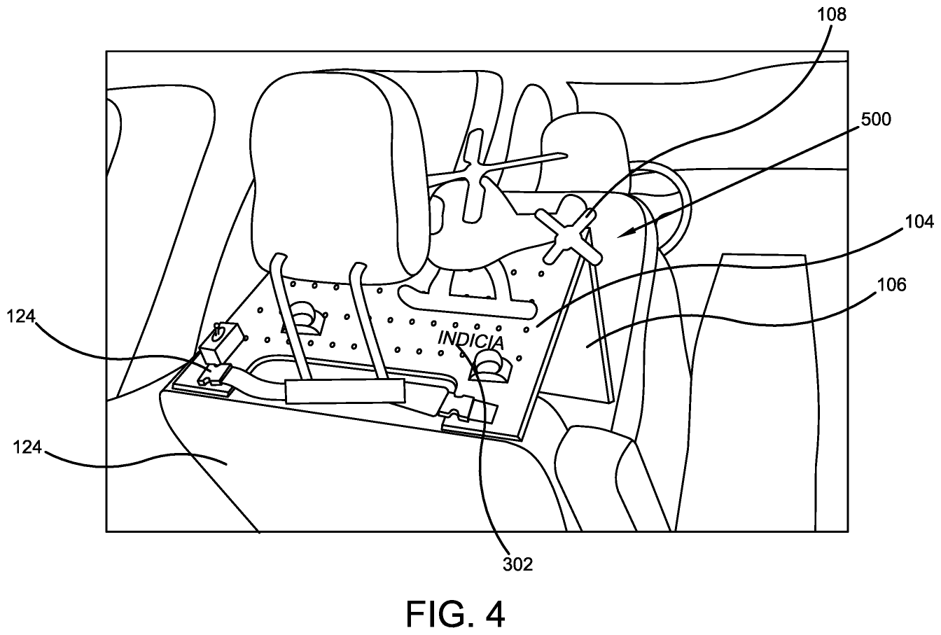

FIG. 4 illustrates a perspective view of another embodiment of the portable activity board device 100 of the present invention. The portable activity board device 100 is manufactured from wood, plastic or polymers, such as polypropylene or acrylonitrile-butadiene-styrene (ABS), polycarbonate, polyethylene, fiberglass, etc., or any other suitable materials as is known in the art. In yet another embodiment, the portable activity board device 100 is manufactured from a material that is water resistant or water permeable, or the housing component 102 comprises a coating that is water resistant or water permeable.

In yet another embodiment of the present invention, a portable activity board device 100 is disclosed for keeping a child 114 happy, entertained, and busy while in a vehicle, a restaurant, or at home, without worry of a child 114 throwing toys 108 and/or losing toys 108. The device 100 comprises a housing component 102 comprising a front 104 and back 106 section secured at an edge 120 via a hinge 122. The hinge 122 allows the front 104 and back 106 sections to be moved in an open and closed position. Once in an open position, the housing component 102 can be secured so as not to overextend its open position. The device 100 is then either secured around a vehicle headrest 116 or placed on a flat surface 118 for use, allowing a child 114 to interact with the multiple toys 108 and/or accessories secured to the front section 104 of the housing component 102.

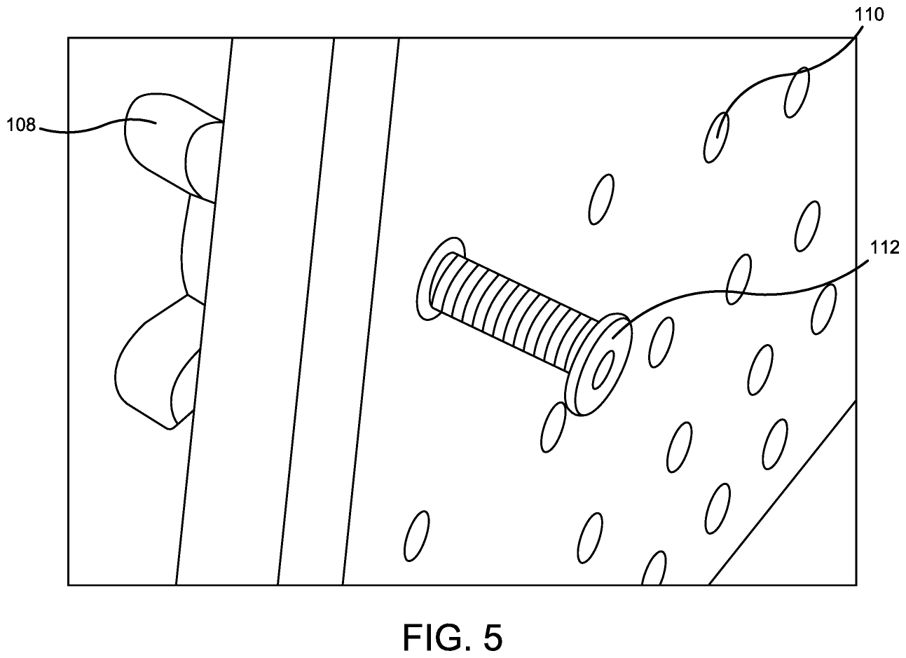

FIG. 5 illustrates a perspective view of another embodiment of the portable activity board device 100 of the present invention. The portable activity board device 100 is sold as a kit 500 with a base set of toys 108 included (see FIG. 4). In another embodiment, supplemental age-based toy kits can be sold, as the child grows. In another embodiment, a subscription-based service can be provided, in which users (parents) can pay a monthly fee to have different types of toys 108 delivered for their child, based on his or her development age and/or interests.

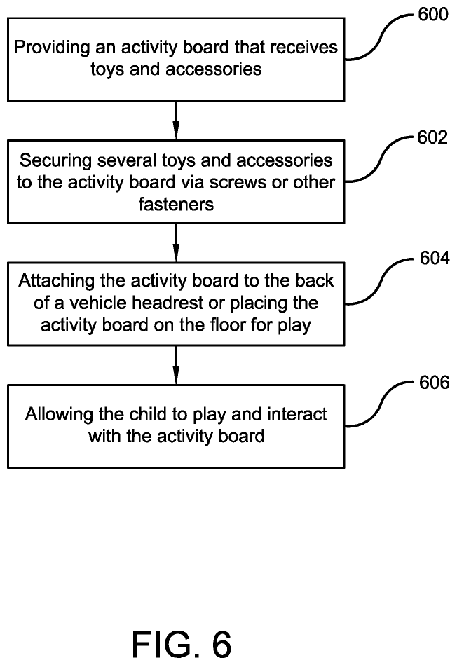

FIG. 6 illustrates a flowchart of the method of keeping a child occupied, entertained, and happy while in a vehicle, at home, or in a restaurant. The method includes the steps of at 600, providing an activity board that receives toys and accessories. The method also comprises at 602, securing several toys and accessories to the activity board via screws or other fasteners. Further, the method comprises at 604, attaching the activity board to the back of a vehicle headrest or placing the activity board on the floor for play. Finally, at 606, allowing the child to play and interact with the activity board.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “portable activity board device” and “device” are interchangeable and refer to the portable activity board device 100 of the present invention.

Notwithstanding the foregoing, the portable activity board device 100 of the present invention can be of any suitable size and configuration as is known in the art without affecting the overall concept of the invention, provided that it accomplishes the above-stated objectives. One of ordinary skill in the art will appreciate that the portable activity board device 100 as shown in FIGS. 1-6 is for illustrative purposes only, and that many other sizes and shapes of the portable activity board device 100 are well within the scope of the present disclosure. Although the dimensions of the portable activity board device 100 are important design parameters for user convenience, the portable activity board device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable activity board device designed to keep a child occupied, entertained and happy while in a vehicle, playing at home, or in a restaurant, the portable activity board device comprising:
a housing component comprising a flat front section and a flat back section; and
a plurality of apertures in the flat front section; and
wherein each of the flat front section and the flat back section are configured in a trapezoidal shape;
wherein each of the flat front section and the flat back section are secured together at an edge via a hinge; and
further wherein a plurality of toys can be attached simultaneously to the plurality of apertures in the flat front section.

2. The portable activity board device of claim 1, wherein the plurality of toys are attached to the plurality of apertures with a fastener.

3. The portable activity board device of claim 2 further comprising a strap for securing the portable activity board device around a headrest of the vehicle via a strap.

4. The portable activity board device of claim 2, wherein the portable activity board device is placed on a flat surface for play.

5. The portable activity board device of claim 1, wherein the hinge allows the flat front section and the flat back section to be repositioned between an open position and a closed position.

6. The portable activity board device of claim 5, wherein, when in the open position, the housing component is configured in a shape of a trapezoid.

7. The portable activity board device of claim 6, wherein the housing component is secured so as not to overextend the open position.

8. The portable activity board device of claim 7, wherein the housing component is secured in an open position via flexible straps.

9. The portable activity board device of claim 5, wherein, when in the closed position, the flat front section and the flat back section of the housing component lay flat on each other.

10. The portable activity board device of claim 1 further comprising a handle secured to either the flat front section or the flat back section for easily transportation of the portable activity board device.

11. The portable activity board device of claim 1 further comprising a plurality of indicia on the housing component.

12. The portable activity board device of claim 1, wherein the portable activity board device is sold as a kit with a base set of toys.

13. A portable activity board device that keeps a child occupied, entertained and happy while in a vehicle, playing at home or in a restaurant, the portable activity board device comprising:
a housing component comprising a flat front section and a flat back section; and
a plurality of apertures configured to receive a plurality of toys secured to the flat front section via at least one screw;
wherein the flat front section and the flat back section are secured together at an edge via a hinge;
wherein the hinge allows the flat front section and the flat back section to be repositioned between an open position and a closed position;
wherein, when in the open position, the housing component is configured in a shape of a trapezoid; and
further wherein in a closed position, the flat front section and the flat back section of the housing component lay flat on each other.

14. The portable activity board device of claim 13 further comprising a strap for securing the portable activity board device around a headrest of a vehicle.

15. The portable activity board device of claim 13, wherein the portable activity board device is configured to be placed on a flat surface for play.

16. The portable activity board device of claim 13, wherein the housing component is secured so as not to overextend the open position via a plurality of flexible straps.

17. The portable activity board device of claim 13 further comprising a handle is secured to either the flat front section or the flat back section.

18. The portable activity board device of claim 13 further comprising a plurality of indicia on the housing component.

19. The portable activity board device of claim 13, wherein the portable activity board device is sold as a kit with a base set of toys.

20. A method of keeping a child occupied, entertained and happy while in a vehicle, at home, or in a restaurant, the method comprising the steps of:
providing an activity board that receives a plurality of toys and accessories;
securing the plurality of toys and accessories to the activity board via a screw or other fastener;
attaching the activity board to a back of a vehicle headrest, or placing the activity board on a floor for play; and
allowing the child to play and interact with the activity board.
